(19) United States
(12) Patent Application Publication
(10) Pub. No.: US 2008/0164659 A1
(43) Pub. Date: Jul. 10, 2008

(54) Metal gasket

(75) Inventor: Yuichi Kinoshita, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: ISHIKAWA GASKET CO., LTD., Tokyo (JP)

(21) Appl. No.: 12/003,978

(22) Filed: Jan. 4, 2008

(30) Foreign Application Priority Data
Jan. 5, 2007 (JP) 2007-000583

(51) Int. Cl. F02F 11/00

(52) U.S. Cl. 277/595

(57) ABSTRACT

A metal gasket is formed of at least two metal plates forming the metal gasket. Each of the two metal plates has a hole to be sealed. A U-shaped ring having an open side and a closed side is situated between the two metal plates such that the open side faces the hole.

### BACKGROUND OF THE INVENTION AND RELATED ART STATEMENT

The present invention relates to a metal gasket held between two members such as a cylinder head and a cylinder block of an engine to seal therebetween. More specifically, the invention relates to a metal gasket which can use a fluid pressure to be sealed for a surface pressure for sealing and offer excellent sealing performance.

A cylinder head gasket is tightened by head bolts and seals fluid such as combustion gas, oil, and coolant water in the state of being held between the cylinder head and the cylinder block (cylinder body) of an automobile engine.

In the cylinder head gasket, in order to prevent combustion gas with a high temperature and corrosive properties from entering between the metal formation plates of the gasket, a grommet which is a U-shaped ring or a folded portion wherein the metal formation plate is folded back is placed and used in such a way as to project to a cylinder bore side (for example, refer to Japanese Patent Publication (TOKKAI) No. 2006-132714).

However, in the case of the above-mentioned grommet, the grommet is placed around the cylinder bore in the state of holding the metal formation plates, so that the grommet member directly abuts against the cylinder head and the cylinder block, and a seal line on the innermost periphery side is formed. Accordingly, in a recent aluminum alloy engine member with low rigidity which tends to be easily scratched, the part of the seal line is scratched, and the sealing performance is deteriorated due to the scratch, so that an appropriate sealing performance can not be obtained. Also, even in a folding-back structure, the folded portion directly abuts against the cylinder head and the cylinder block, and forms the seal line on the innermost periphery side, so that the above-mentioned problem may occur.

This invention is made in order to solve the above-mentioned problems, and an object of the present invention is to provide a metal gasket which can improve the sealing performance around the sealing target bore such as the cylinder bore of the engine using the pressure of fluid of the sealing target.

Further objects and advantages of the invention will be apparent from the following description of the invention.

### SUMMARY OF THE INVENTION

In order to achieve the objects described above, according to the present invention, a metal gasket including two or more sheets of metal formation plates held between two members for sealing, comprises a U-shaped ring projecting to the outer periphery side between the two sheets of metal formation plates in a part facing the sealing target bore. According to the structure, when the pressure of fluid of a sealing target such as the combustion gas of an engine is elevated, the fluid entered into the U-shaped ring opens the U-shaped ring, and the metal formation plates on both sides holding the U-shaped ring is pressed to the members. Consequently, the fluid of the sealing target becomes more difficult to enter between the metal formation plates, and the pressure of fluid of the sealing target can be used for sealing surface pressure, so that the sealing performance improves.

In the metal gasket, a half bead whose sealing target bore side is open may be provided in at least one of the two sheets of metal formation plates, and the U-shaped ring is placed on the inside of the half bead. If the half bead is provided, the U-shaped ring can be easily placed, and a seal line can be formed in a flat part on the sealing target bore side with a relatively wide width. As a result, a scratch or indentation of an engine member can be controlled, and in addition to the sealing function of the half bead, the sealing performance further improves.

In the metal gasket, a full bead projecting to the outside may be placed in the sealing target bore side portion of the half bead. According to the structure, in addition to the pressing force of the half bead, the pressing force of the full bead can be added, so that a seal line of a strong pressing force can be formed.

Moreover, according to the metal gasket, a seal ring may be placed on the inside of the U-shaped ring. According to the structure, even when the open side of the U-shaped ring is pressed, the seal ring such as a wire ring and the like can prevent the open side of the U-shaped ring from being crushed. Therefore, it is possible to prevent the situation such that the open side of the U-shaped ring is crushed and this causes a gap between the U-shaped ring and the metal formation plates holding the U-shaped ring on the sealing target bore side to cause the fluid entering into the gap. Thus, the sealing performance can further be improved.

According to the metal gasket of the invention, since the U-shaped ring projecting to the outer periphery side is provided, when the pressure of fluid of the sealing target is elevated, the fluid entered into the U-shaped ring opens the U-shaped ring, and presses the metal formation plates on both sides holding the U-shaped ring in the member direction. Therefore, the fluid hardly enters between the metal formation plates, and the pressure of the fluid can be used for the sealing surface pressure, so that the sealing surface pressure is elevated, and the sealing performance can be improved.

### BRIEF DESCRIPTION OF THE DRAWINGS

FIG. 1 is a fragmentary sectional view showing a cylinder head gasket according to the first embodiment of the present invention;

FIG. 2 is a fragmentary sectional view showing the cylinder head gasket according to the second embodiment of the present invention;

FIG. 3 is a fragmentary sectional view showing the cylinder head gasket according to the third embodiment of the present invention;

FIG. 4 is a fragmentary sectional view showing the cylinder head gasket according to the fourth embodiment of the present invention;

FIG. 5 is a fragmentary sectional view showing the cylinder head gasket according to the fifth embodiment of the present invention;

FIG. 6 is a fragmentary sectional view showing the cylinder head gasket according to the sixth embodiment of the present invention; and

FIG. 7 is a fragmentary sectional view showing the cylinder head gasket according to the seventh embodiment of the present invention.

### DETAILED DESCRIPTION OF PREFERRED EMBODIMENTS

Hereunder, metal gaskets according to the embodiments of the present invention will be described as examples of the cylinder head gaskets with reference to the attached drawings. Incidentally, FIGS. 1, 2 are schematic explanatory views in which the thicknesses of the plates, and sizes of the sealing target bore, folded portion, and beads are different from actual ones, so that the cylinder head gasket is enlarged for the sake of explanation.

The metal gasket according to the invention is a cylinder head gasket held between engine members such as a cylinder head and a cylinder block (cylinder body) of an engine to seal fluid such as high-temperature and high-pressure combustion gas in a cylinder bore, and coolant water or oil in passages for the coolant water or cooling oil.

The cylinder head gasket is formed of multiple sheets of metal formation plates (metal plates or substrates) made of soft steel, annealed stainless (annealed material), or stainless material (spring steel). Also, the cylinder head gasket is produced in a shape corresponding to the shape of the engine member such as the cylinder block, and is provided with a cylinder bore (combustion chamber hole), fluid hole for circulating the coolant water or engine oil, or bolt holes for tightening head bolts.

As shown in FIG. 1, a cylinder head gasket 1 of the first embodiment of the invention comprises two sheets of metal plates or metal formation plates 10, 20, and a U-shaped ring 30 projecting to the outer periphery side. The first metal formation plate 10 and the second metal formation plate 20 are made of annealed stainless, and the U-shaped ring 30 is made of stainless spring steel.

In the periphery of the cylinder bore 2, the first metal formation plate 10 is provided with a half bead 11 whose cylinder bore 2 side is open, and the second metal formation plate 20 is provided with a half bead 21 whose cylinder bore 2 side is open. A U-shaped ring 30 whose outer periphery side has a round portion (folded portion) 31 is placed between the above-mentioned two half beads 11, 21. Incidentally, even on a water hole 3 side, the first metal formation plate 10 is provided with a half bead 12 whose water hole 3 side is open, and the second metal formation plate 20 is provided with a half bead 22 whose water hole 3 side is open.

According to the structure, when the pressure of the combustion gas of the engine is elevated, the pressure acts in a direction wherein the U-shaped ring 30 opens by the pressure of the combustion gas entered into the U-shaped ring 30, so that the metal formation plates 10, 20 on both sides holding the U-shaped ring 30 are pressed in the directions of the cylinder head and the cylinder block. Therefore, the combustion gas hardly enters between the metal formation plates 10, 20, and the pressure of the combustion gas can be used for the sealing surface pressure, so that the sealing performance improves.

Also, due to the half beads 11, 21, the U-shaped ring 30 can be easily placed, and the seal line can be formed in the flat part on the sealing target bore side with a relatively wide width, so that a scratch or indentation on the engine member can be controlled. Moreover, since the sealing functions of the half beads 11, 21 are added, the sealing performance improves furthermore.

As shown in FIG. 2, a cylinder head gasket 1A of the second embodiment of the invention comprises three sheets of metal formation plates 10A, 20A, 40 and the U-shaped ring 30 projecting to the outer periphery side. In the second embodiment, the third metal formation plate 40 is held between the first metal formation plate 10 and the second metal formation plate 20 in the first embodiment. The second embodiment is the same as the first embodiment except for the above-mentioned structure.

When the third metal formation plate 40 is placed, the thickness of the gasket 1A can be easily adjusted, so that the U-shaped ring 30 can be easily placed. Also, the half beads 11, 21 are not required to be provided in a steeply-inclined manner, so that the half beads 11, 21 can easily adjust the sealing surface pressure.

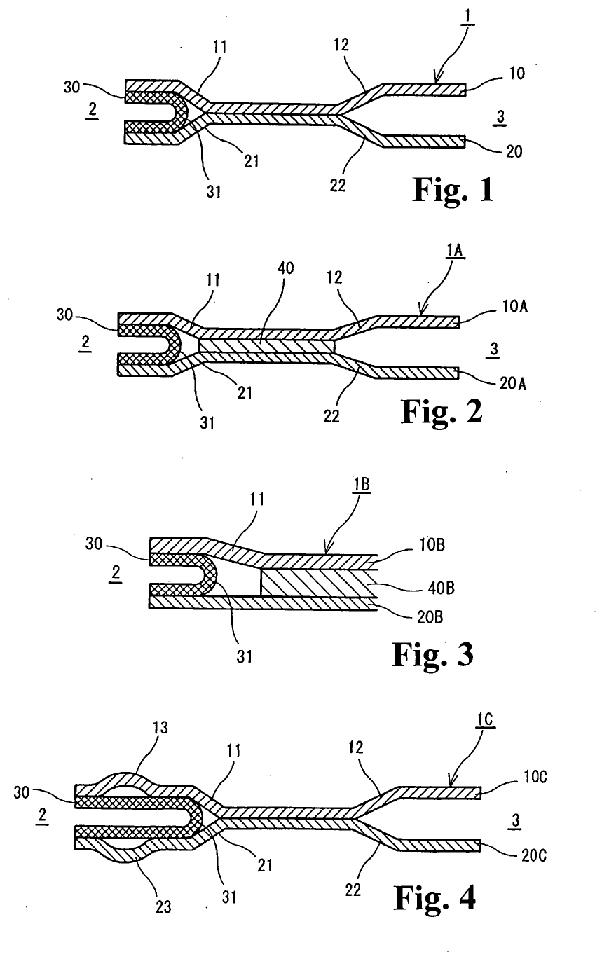

As shown in FIG. 3, a cylinder head gasket 1B of the third embodiment of the invention comprises three sheets of metal formation plates 10B, 20B, 40B, and the U-shaped ring 30 projecting to the outer periphery side. In the third embodiment, without providing the half bead 21 provided in the second metal formation plate 20A as in the case of the second embodiment, the second metal formation plate 20B is formed flatly on the periphery of the cylinder bore 2. Also, the U-shaped ring 30 is placed between the half bead 11 of the first metal formation plate 10B and the flat part of the second metal formation plate 20B. The third embodiment has the same structure as in the second embodiment except for the above-mentioned structure. In the third embodiment, one half bead 11 is used as compared to the second embodiment, so that the surface pressure of the seal line can be reduced.

In the structures of the first-third embodiments, the bore surface pressure can be produced using a gas pressure. However, a high surface pressure cannot be expected. Therefore, the indentation in the bore part of the aluminum alloy engine member can be reduced. Additionally, since the pressure of the combustion gas can be used, a following capability can be improved as well as a gas sealing capability. As a result, the structures are suitable for especially, an aluminum alloy open-deck type gasoline engine.

As shown in FIGS. 4-6, cylinder head gaskets 1C, 1D, 1E of the fourth-sixth embodiments of the invention are provided with full beads 13, 23 on the cylinder bore 2 side of the half bead 11 of the first metal formation plates 10, 10A, 10B and the cylinder bore 2 side of the half bead 21 of the second metal formation plates 20, 20A, in the cylinder head gasket 1, 1A, 1B of the first-third embodiments, respectively. By forming the seal line with a high sealing surface pressure by the full beads 13, 23, these gaskets can be applied to an engine with a high pressure of combustion gas such as a diesel engine.

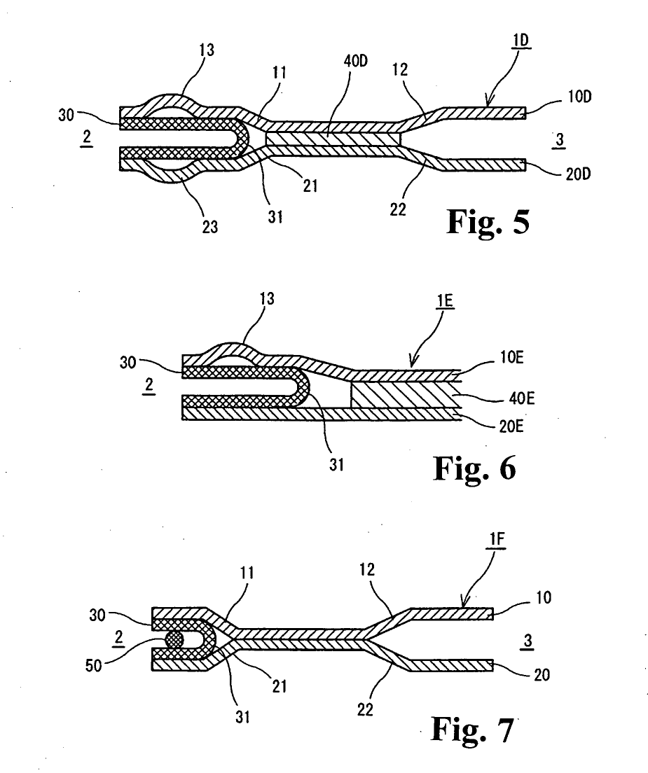

Incidentally, in the embodiments in FIGS. 4, 5, the full beads 13, 23 are provided on both sides of the first metal formation plates 10C, 10D and the second metal formation plates 20C, 20D. However, the full beads 13, 23 can be provided in only either one, and the sealing surface pressure can be reduced. The structures of the half beads 11, 21 or the full beads 13, 23 are selected according to a required sealing surface pressure. In the embodiment in FIG. 6, the full bead 13 is provided on the metal formation plate 10E. Incidentally, in the above, the full beads 13, 23 are explained with the circular bead of the cross-sectional shape. However, the shape of the bead is not specially limited in this invention, and the cross-sectional shape may be a circular arc, sine (cosine), trapezoid, triangle (mountain shape), and so on.

Additionally, as shown in FIG. 7, a metal gasket 1F of the seventh embodiment is provided with a seal ring 50 such as a wire ring on the inside of the U-shaped ring 30, in the metal gasket 1 of the first embodiment. According to the structure, even when the open side of the U-shaped ring is pressed, the open side of the U-shaped ring 30 can be prevented from being crushed by the seal ring 50. Therefore, it is possible to prevent the situation such that the open side of the U-shaped ring 30 is crushed and this causes a gap between the U-shaped ring 30 and the metal formation plates 10, 20 holding the ring 30 on the sealing target bore 2 side to allow the gas to enter into the gap. As a result, the sealing performance can further improve.

Incidentally, the structure providing the seal ring 50 such as the wire ring on the inside of the U-shaped ring 30, can be practiced even in the second-sixth embodiments, and the same effect as the seventh embodiment can be achieved.

The disclosure of Japanese Patent Application No. 2007-000583, filed on Jan. 5, 2007, is incorporated in the application.

While the invention has been explained with reference to the specific embodiments of the invention, the explanation is illustrative and the invention is limited only by the appended claims.

What is claimed is:

1. A metal gasket comprising:
two metal plates forming the metal gasket, each of said two metal plates having a hole to be sealed, and
a U-shaped ring having an open side and a closed side, said U-shaped ring being situated between the two metal plates such that the open side faces the hole.

2. A metal gasket according to claim 1, wherein at least one of the two metal plates is provided with a half bead adjacent to the hole, said U-shaped ring being provided inside the half bead.

3. A metal gasket according to claim 2, wherein said two metal plates are provided with half beads adjacent to the hole to be arranged symmetrically relative to a plane therebetween, said U-shaped ring being provided between the half beads.

4. A metal gasket according to claim 2, further comprising an additional metal plate situated between the two metal plates at a portion outside the half bead relative to the hole.

5. A metal gasket according to claim 2, wherein at least one of the two metal plates is provided with a full bead at an inside of the half bead relative to the hole, said full bead projecting in a direction same as that the half bead.

6. A metal gasket according to claim 1, further comprising a seal ring provided on an inside of the U-shaped ring.

7. A metal gasket according to claim 1, wherein said two metal plates further include liquid holes, and half beads for sealing the liquid hole.
